(19) United States
(12) Patent Application Publication
(10) Pub. No.: US 2023/0417968 A1
(43) Pub. Date: Dec. 28, 2023

(54) DISPLAY MODULE

(71) Applicant: HENGHAO TECHNOLOGY CO., LTD., Hsin-chu County (TW)

(72) Inventors: Wen-Jung Tsai, Taichung City (TW); Hui-Jung Tsai, Changhua County (TW); Ching-Yu Tsai, Tainan City (TW)

(73) Assignee: HENGHAO TECHNOLOGY CO., LTD., Hsin-chu County (TW)

(21) Appl. No.: 18/199,383

(22) Filed: May 19, 2023

(30) Foreign Application Priority Data
Jun. 14, 2022 (TW) 111121932

(51) Int. Cl. G02B 5/26

(52) U.S. Cl. CPC G02B 5/26

(57) ABSTRACT

A display module has a touch display area, a non-touch display area and a frame area surrounding them. The display module includes a cover plate, an ink layer, a touch display panel, a non-touch display panel and an optical matching layer. The ink layer is disposed on the cover plate and corresponds to the frame area. The touch display panel and the non-touch display panel are disposed on a side of the ink layer opposite to the cover plate and respectively correspond to the touch display area and the non-touch display area. The optical matching layer is disposed between the cover plate and one of the touch display panel and the non-touch display panel. A difference of average reflectance to external light between any two of the above areas is less than 1.5%, and a chromaticity difference between any two of the above areas is less than 1.5.

### BACKGROUND OF THE INVENTION

### 1. Field of the Invention

The present invention relates to a display module, and more particularly to a display module having a touch display area, a non-touch display area and a frame area.

### 2. Description of the Prior Art

In recent years, display modules including touch functions have been widely applied in various electronic products, such as smart phones, tablets, notebook computers, televisions or vehicle displays. A vehicle display can include a variety of display panels, such as a dashboard and a central control panel, wherein the dashboard and the central control panel may have different designs due to their different functions. In the related art, when no image is displayed by the dashboard and the central control panel, the appearance and color of the dashboard, the central control panel and the surrounding frames thereof are different from each other. This causes various areas of the vehicle display to be visually inconsistent, thereby affecting the aesthetics and design sense of the vehicle display.

### SUMMARY OF THE INVENTION

One of the objectives of the present invention is therefore to provide a display module, wherein the touch display area, the non-touch display area and the frame area are visually consistent, so that the display module can achieve a more uniform and consistent visual performance when no image is displayed.

An embodiment of the present invention provides a display module, which has at least one touch display area, at least one non-touch display area and a frame area, and the frame area surrounds the touch display area and the non-touch display area. The display module includes a cover plate, an ink layer, at least one touch display panel, at least one non-touch display panel and an optical matching layer. The ink layer is disposed on a surface of the cover plate and corresponds to the frame area. The touch display panel is disposed on a side of the ink layer opposite to the cover plate and corresponds to the touch display area. The non-touch display panel is disposed on a side of the ink layer opposite to the cover plate and corresponds to the non-touch display area. The optical matching layer is disposed between the cover plate and one of the touch display panel and the non-touch display panel. A difference of average reflectance to external light between any two of the touch display area, the non-touch display area and the frame area is less than 1.5%, and a chromaticity difference between any two of the touch display area, the non-touch display area and the frame area is less than 1.5.

According to the display module of the present invention, through matching of the optical matching layer and the panel, the difference of average reflectance and the chromaticity difference between the touch display area, the non-touch display area and the frame area may be designed to be less than specific values, so that these areas are visually consistent. Therefore, the display module can achieve a visual performance with a consistent color appearance when no image is displayed, for example, presenting a visual effect of uniform black. In addition, by disposing the high reflective ink in the frame area, the visual consistency of the display module may be further improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top-view schematic diagram of a display module according to an embodiment of the present invention.

FIG. 2 is a top-view schematic diagram of a display module according to another embodiment of the present invention.

FIG. 3 is a partial cross-sectional schematic diagram of a display module according to a first embodiment of the present invention.

FIG. 4 is a schematic diagram of the relationship between the reflectance of different areas of the display module and measured wavelength according to an embodiment of the present invention.

FIG. 5 is a schematic diagram of the relationship between the reflectance of different areas of the display module and measured wavelength according to another embodiment of the present invention.

FIG. 6 is a schematic diagram of the relationship between the reflectance of different areas of the display module and measured wavelength according to yet another embodiment of the present invention.

FIG. 7 is a partial cross-sectional schematic diagram of a display module according to a second embodiment of the present invention.

FIG. 8 is a partial cross-sectional schematic diagram of a display module according to a third embodiment of the present invention.

### DETAILED DESCRIPTION

The present invention may be understood by reference to the following detailed description, taken in conjunction with the drawings, which are described in further detail below. It is noted that, for purposes of illustrative clarity and ease of understanding by the readers, various drawings of the present invention show at least a portion of the display module or the structure, and certain components in various drawings may not be drawn to scale. In addition, the number and dimension of each component shown in drawings are only illustrative and are not intended to limit the scope of the present invention.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to . . . ”. When the terms “include”, “comprise” and/or “have” are used in the description of the present invention, the corresponding features, areas, steps, operations and/or components would be pointed to existence, but not limited to the existence or addition of one or a plurality of the corresponding or other features, areas, steps, operations, components and/or combinations thereof.

When an element or layer is referred to as being “on” or “connected to” another element or layer, it may be directly on or directly connected to the other element or layer, or intervening elements or layers may be presented (indirect condition). In contrast, when an element is referred to as being “directly on” or “directly connected to” another element or layer, there are no intervening elements or layers presented.

It should be noted that the technical features in different embodiments described in the following can be replaced, recombined, or mixed with one another to constitute another embodiment without departing from the spirit of the present invention.

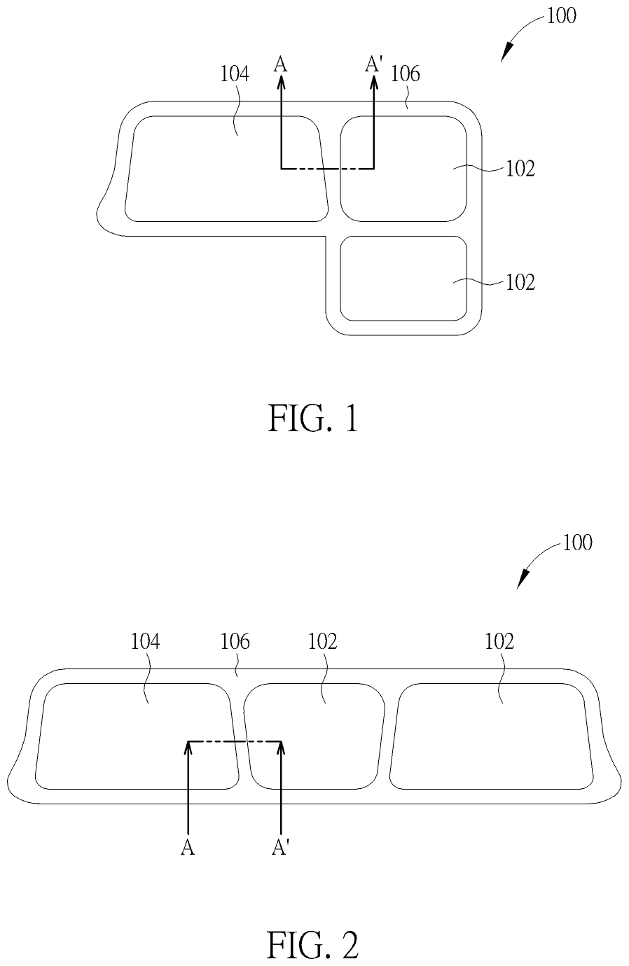

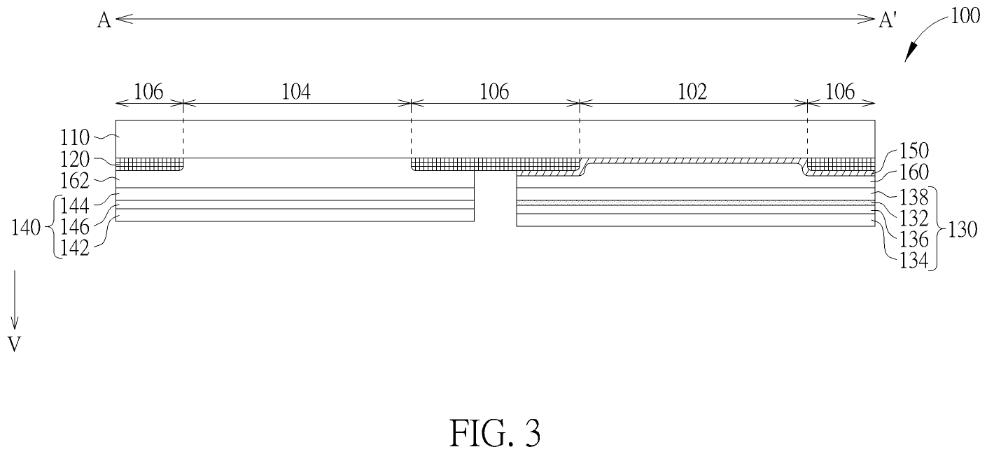

Refer to FIG. 1, FIG. 2 and FIG. 3. FIG. 1 is a top-view schematic diagram of a display module according to an embodiment of the present invention. FIG. 2 is a top-view schematic diagram of a display module according to another embodiment of the present invention. FIG. 3 is a partial cross-sectional schematic diagram of a display module according to a first embodiment of the present invention; for example, a cross-sectional schematic diagram along the section line A-A′ of FIG. 1 or FIG. 2. As shown in FIG. 1, FIG. 2 and FIG. 3, a display module 100 of the present invention has at least one touch display area 102, at least one non-touch display area 104 and a frame area 106, and the frame area 106 surrounds the touch display area 102 and the non-touch display area 104. The touch display area 102 may be adjacent to the non-touch display area 104; for example, the touch display area 102 may be located on one side of the non-touch display area 104, but not limited herein. The touch display area 102 may have both touch and display functions, the non-touch display area 104 has display function but does not have touch function, and the frame area 106 does not have display and touch functions, that is, the frame area 106 may also be referred to as a non-display area.

In some embodiments, the display module 100 may be, for example, a vehicle display. As shown in FIG. 1, the display module 100 may include two touch display areas 102 and a non-touch display area 104, and the non-touch display area 104 and one of the touch display areas 102 are respectively located on the left side and the lower side of the other touch display area 102. Furthermore, the two touch display areas 102 may be used as a central control panel located at the center console between a driver's seat and a passenger's seat of a vehicle, and the non-touch display area 104 may be used as a dashboard located in front of the driver's seat, but not limited herein. In other embodiments, as shown in FIG. 2, the display module 100 may include two touch display areas 102 and a non-touch display area 104, and the non-touch display area 104 and one of the touch display areas 102 are respectively located on opposite sides of the other touch display area 102. Furthermore, one of the touch display areas 102 may be used as a control panel for the passenger and located in front of the passenger's seat, the other touch display area 102 may be used as a central control panel located at the center console, and the non-touch display area 104 may be used as a dashboard located in front of the driver's seat, but not limited herein. In other embodiments, the number, arrangement and application of the touch display area 102 and the non-touch display area 104 in the display module 100 may be adjusted according to practical requirements.

As shown in FIG. 3, the display module 100 may include a cover plate 110, an ink layer 120, at least one touch display panel 130, at least one non-touch display panel 140 and an optical matching layer 150. The cover plate 110 may include, for example, a cover glass, and the refractive index of the cover plate 110 for light with a wavelength of 550 nanometers (nm) may be 1.51 to 1.53, but not limited herein. The ink layer 120 is disposed on a surface of the cover plate 110 and corresponds to the frame area 106. For example, black ink may be coated on the surface of the cover plate 110 at the position corresponding to the frame area 106 to form the ink layer 120, but not limited herein.

In some embodiments, the ink layer 120 may include a normal ink, where an L* value of the normal ink in the CIE 1976 color space may be greater than or equal to 25 and less than or equal to 26 (i.e., 26≥L*≥25). In other embodiments, the ink layer 120 may include a high reflective ink, where an L* value of the high reflective ink in the CIE 1976 color space may be greater than 28 (i.e., L*>28), but not limited herein. The difference between the high reflective ink and the normal ink may be that the ratio of white ink in the ink is increased, so as to increase the L* value of the ink and improve the reflectance. Table 1 exemplified shows the average reflectance Ravg (unit: %) to external light of the frame area 106 and the color coordinate values L*, a* and b* in the CIE 1976 color space of the frame area 106 when the ink layer 120 includes the normal ink and the highly reflective ink. The external light in the present invention means the light emitted from the light source outside the display module 100 toward the cover plate 110, and is used for measuring the reflectance. For example, the CM3700D and CM2600D measuring equipment produced by the company of Konica Minolta may be used for measurement, but not limited herein. In addition, the external light may be visible light, and the wavelength thereof may range from 400 nm to 700 nm or from 380 nm to 780 nm.

TABLE 1

| material of the | average reflectance Ravg (%) | color coordinate value | | |
|---|---|---|---|---|
| ink layer | (wavelength: 400-700 nm) | L* | a* | b* |
| normal ink | 4.48 | 25.14 | −0.03 | −0.52 |
| highly reflective | 6.05 | 29.46 | 0.02 | −0.59 |
| ink | | | | |

The average reflectance Ravg referred to in the present invention means the average value of reflectance measured in the wavelength range of visible light, which is calculated by the following formula (1):

$$Ravg = \frac{1}{N} {\sum }_{i = 1}^{N} R ( {λ}_{i} ) \qquad ( 1 )$$

In the formula (1), R(λᵢ) represents the reflectance measured at a specific wavelength λᵢ. For example, the specific wavelength λᵢ is selected from the range of 400 nm to 700 nm of the wavelength range of visible light; when i=1, λᵢ is 400 nm; when i=N, λ_{N} is 700 nm; and other values may be obtained by inference accordingly. For example, a reflectance may be obtained every 10 nm in the wavelength range of 400 nm to 700 nm, and the average reflectance Ravg as shown in Table 1 may be obtained according to the formula (1), but not limited herein.

The touch display panel 130 may be disposed on a side of the ink layer 120 opposite to the cover plate 110 and correspond to the touch display area 102. Specifically, as shown in FIG. 3, a portion of the touch display panel 130 may be overlapped with the ink layer 120 in a top-view direction V of the display module 100 and located in the frame area 106, and another portion of the touch display panel 130 is not overlapped with the ink layer 120 in the top-view direction V and corresponds to the touch display area 102, that is, the portion of the touch display panel 130 that is not overlapped with the ink layer 120 (or the portion thereof exposed by the ink layer 120) belongs to the touch display area 102.

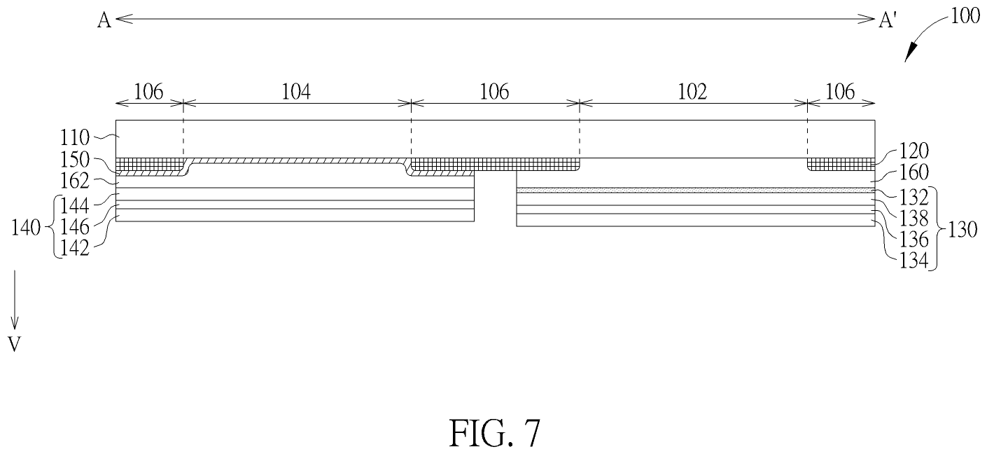

The touch display panel 130 may include a touch layer 132, which may be an in-cell touch display panel shown in FIG. 3 or an on-cell touch display panel shown in FIG. 7, for example. Taking the touch display panel 130 shown in FIG. 3 as an example, the touch display panel 130 may include a first substrate 134, a display layer 136, a touch layer 132 and a second substrate 138 stacked in sequence in a direction opposite to the top-view direction V, so as to form an in-cell touch display panel, but not limited herein. The display layer 136 may include a display medium, such as including liquid crystal, light emitting diodes (LEDs), quantum dots (QDs), fluorescence or phosphor. The light emitting diode may include an organic light emitting diode (OLED), a mini light emitting diode (mini LED), a micro light emitting diode (micro LED) or a quantum dot light emitting diode (quantum dot LED, or QDLED), but not limited herein.

The non-touch display panel 140 may be disposed on a side of the ink layer 120 opposite to the cover plate 110 and correspond to the non-touch display area 104. Specifically, as shown in FIG. 3, a portion of the non-touch display panel 140 may be overlapped with the ink layer 120 in the top-view direction V of the display module 100 and located in the frame area 106, and another portion of the non-touch display panel 140 is not overlapped with the ink layer 120 in the top-view direction V and corresponds to the non-touch display area 104, that is, the portion of the non-touch display panel 140 that is not overlapped with the ink layer 120 (or the portion thereof exposed by the ink layer 120) belongs to the non-touch display area 104. The non-touch display panel 140 includes a display layer but does not include a touch layer. Taking the non-touch display panel 140 shown in FIG. 3 as an example, the non-touch display panel 140 may include a first substrate 142, a display layer 146 and a second substrate 144 stacked in sequence in the direction opposite to the top-view direction V, but not limited herein. Compared with the touch display panel 130, the non-touch display panel 140 does not have the touch layer 132. The display layer 146 may include a display medium, which may be understood by referring to the above description of the display layer 136 and will not be repeated herein.

The optical matching layer 150 may be disposed between the cover plate 110 and one of the touch display panel 130 and the non-touch display panel 140 for adjusting optical properties (such as reflectance and/or chromaticity). Taking the display module 100 shown in FIG. 3 as an example, the optical matching layer 150 may be disposed between the touch display panel 130 and the cover plate 110, but not limited herein. In some embodiments, a portion of the optical matching layer 150 may further be disposed between the touch display panel 130 and the ink layer 120, that is, the optical matching layer 150 may be disposed corresponding to the touch display area 102 and a portion of the frame area 106 surrounding the touch display area 102. Since the optical matching layer 150 is not located between the cover plate 110 and the ink layer 120 in the top-view direction V, the influence on the optical properties of the frame area 106 may be reduced.

In some embodiments, the optical matching layer 150 may be a single-layer structure, and the optical matching layer 150 may include a high refractive index material, a low refractive index material or a transparent material with a refractive index therebetween. The high refractive index material may include, for example, niobium pentoxide (Nb₂O₅), titanium dioxide (TiO₂), tantalum pentoxide (Ta₂O₅), silicon oxynitride (SiOₓN_{y}), silicon nitride (SiₓN_{y}, such as Si₃N₄) or other suitable materials. The low refractive index material may include, for example, silicon dioxide (SiO₂), magnesium fluoride (MgF₂) or other suitable materials. In some embodiments, the optical matching layer 150 may be an Nb₂O₅ layer with a layer thickness ranging from 54 angstroms (Å) to 66 Å, but not limited herein. In other embodiments, the optical matching layer 150 may be a SiOₓN_{y} layer with a layer thickness ranging from 108 Å to 132 Å, but not limited herein. Table 2 exemplified shows the high and low refractive index materials described above and the corresponding refractive indices at a wavelength of 550 nm thereof, but not limited herein.

TABLE 2

| | refractive index |
|---|---|
| material of the optical matching layer | (wavelength: 550 nm) |

| | | |
|---|---|---|
| high refractive index material | Nb₂O₅ | 2.27~2.35 |
| | TiO₂ | 2.16~2.44 |
| | Ta₂O₅ | 2.12~2.23 |
| | SiOₓN_{y} | 1.86~1.95 |
| | Si₃N₄ | 2.02~2.05 |
| low refractive index material | SiO₂ | 1.46~1.48 |
| | MgF₂ | 1.38 |

In some embodiments, the optical matching layer 150 may be a multi-layer structure and include at least one first sub-layer and at least one second sub-layer which are alternately stacked, where a refractive index of the first sub-layer is greater than a refractive index of the second sub-layer. The material of the first sub-layer may include the high refractive index material described above, and the material of the second sub-layer may include the low refractive index material described above, but not limited herein. The numbers and the stacking arrangement of the first sub-layer and the sub-layer may be adjusted according to practical requirements. In some embodiments, the optical matching layer 150 is formed by stacking an Nb₂O₅ layer (with a layer thickness ranging from 90 Å to 110 Å), a SiO₂ layer (from 342 Å to 418 Å), an Nb₂O₅ layer (from 963 Å to 1177 Å) and a SiO₂ layer (from 891 Å to 1089 Å) from the top to the bottom along the top-view direction V in sequence, but not limited herein.

As shown in FIG. 3, in some embodiments, the display module 100 may further include an adhesive layer 160. The adhesive layer 160 is disposed between the touch display panel 130 and the optical matching layer 150 to attach the touch display panel 130 to the optical matching layer 150. In addition, the display module 100 may further include another adhesive layer 162. The adhesive layer 162 is disposed between the non-touch display panel 140 and both the cover plate 110 and the ink layer 120 to attach the non-touch display panel 140 to the cover plate 110 and the ink layer 120. The adhesive layer 160 and the adhesive layer 162 may include, for example, an optical clear adhesive (OCA) or other suitable adhesive materials, but not limited herein.

In the manufacturing process of the display module 100 of the first embodiment, the patterned optical matching layer 150 may be formed after the ink layer 120 is formed on the surface of the cover plate 110. For example, the material layer of the optical matching layer 150 may be formed on the surface of the cover plate 110 by a process such as coating, printing or thin-film deposition, and a mask may be used to remove a portion of the material layer for patterning when it was formed blanketly or with a large area, so that the remaining material layer corresponds to the touch display area 102 and a portion of the frame area 106 surrounding the touch display area 102 to form the optical matching layer 150. In this method, the optical matching layer 150 is formed on the surfaces of the cover plate 110 and the ink layer 120, so that the optical matching layer 150 covers the corresponding cover plate 110 and ink layer 120 stepwise, that is, the optical matching layer 150 is formed conformally based on the shape of the cover plate 110 and the ink layer 120. Then, the touch display panel 130 may be attached to the optical matching layer 150 through the adhesive layer 160, and the non-touch display panel 140 may be attached to the cover plate 110 and the ink layer 120 through the adhesive layer 162, but not limited herein.

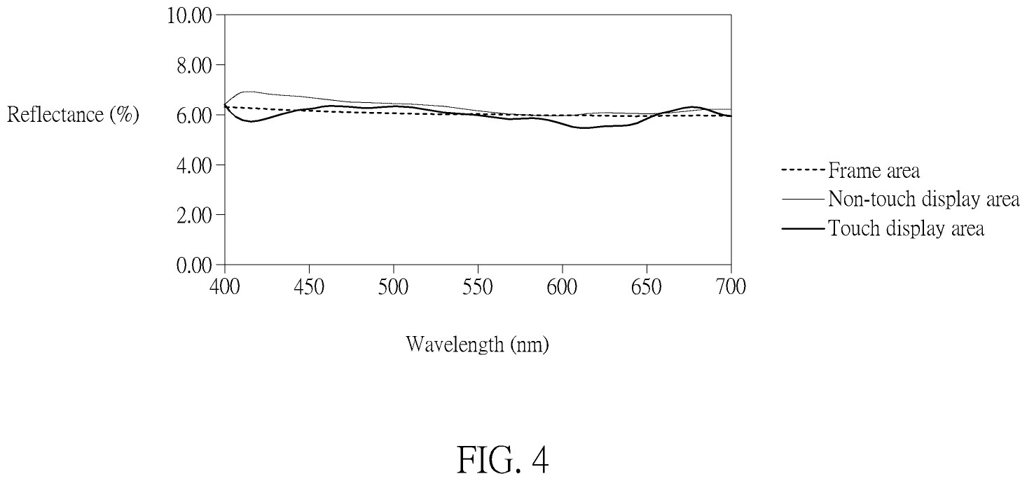

Refer to FIG. 4 and Table 3, along with FIG. 3. FIG. 4 is a schematic diagram of the relationship between the reflectance of different areas of the display module and the measured wavelength according to an embodiment of the present invention. Table 3 exemplified shows the average reflectance Ravg (unit: %) and the difference of average reflectance ΔR (unit: %) to external light and the color coordinate values L*, a* and b* and the chromaticity difference ΔE in the CIE 1976 color space of various areas of the display module 100 according to an embodiment of the present invention, which will be detailed in the following paragraphs. As shown in FIG. 3, FIG. 4 and Table 3, in the display module 100 of this embodiment, the ink layer 120 of the frame area 106 is formed of the highly reflective ink, and the optical matching layer 150 disposed between the touch display panel 130 and the cover plate 110 is formed by stacking an Nb₂O₅ layer (with a layer thickness of 100 Å), a SiO₂ layer (380 Å), an Nb₂O₅ layer (1070 Å) and a SiO₂ layer (990 Å) from the top to the bottom along the top-view direction V in sequence.

TABLE 3

| | average | | | | | |
|---|---|---|---|---|---|---|
| | reflectance | difference | | | | chroma- |
| | Ravg (%) | of average | | | | ticity |
| | (wavelength: | reflectance | color coordinate value | | | difference |
| area | 400-700 nm) | ΔR (%) | L* | a* | b* | ΔE |
| frame area | 6.05 | | 29.46 | 0.02 | −0.59 | |
| 106 | | | | | | |
| non-touch | 6.30 | 0.26 | 29.89 | −0.26 | −1.94 | 1.45 |
| display | | | | | | |
| area 104 | | | | | | |
| touch | 6.01 | 0.22 | 29.28 | −1.25 | −1.10 | 1.38 |
| display | | | | | | |
| area 102 | | | | | | |

The average reflectance Ravg of each area is the average value of reflectance to external light (visible light with a wavelength ranging from 400 nm to 700 nm), which may be obtained by the formula (1) described above, and will not be described herein. For example, a reflectance may be obtained every 10 nm in the wavelength range of 400 nm to 700 nm, and the average reflectance Ravg as shown in Table 3 may be obtained according to the formula (1), but not limited herein.

The difference of average reflectance ΔR referred to in the present invention means the average of the absolute values of the differences of reflectance between two points in different areas for each specific wavelength, which is calculated by the following formula (2):

$$Δ R = \frac{1}{N} {\sum }_{i = 1}^{N} \vert {R}_{1} ( {λ}_{i} ) - {R}_{2} ( {λ}_{i} ) \vert \qquad ( 2 )$$

In the formula (2), R₁(λᵢ) represents the reflectance measured at a specific wavelength λᵢ in an area 1 (such as one of the frame area 106, the non-touch display area 104 and the touch display area 102), and R₂(λᵢ) represents the reflectance measured at the specific wavelength λᵢ in an area 2 (such as another one of the frame area 106, the non-touch display area 104 and the touch display area 102). The specific wavelength λᵢ is selected from the range of 400 nm to 700 nm of the wavelength; when i=1, λᵢ is 400 nm; when i=N, λ_{N} is 700 nm; and other values may be obtained by inference. For example, a reflectance may be obtained every 10 nm in the range of 400 nm to 700 nm of the wavelength, and the difference of average reflectance ΔR as shown in Table 3 may be obtained according to the formula (2), but not limited herein. Referring to Table 3, based on the frame area 106, a difference of average reflectance ΔR to external light (with the wavelength ranging from 400 nm to 700 nm) between the non-touch display area 104 and the frame area 106 is 0.26%, and a difference of average reflectance ΔR to external light (with the wavelength ranging from 400 nm to 700 nm) between the touch display area 102 and the frame area 106 is 0.22%.

The chromaticity difference ΔE referred to in the present invention means the difference of chromaticity between different areas, which is calculated by the following formula (3):

ΔE=\sqrt{(L₁*−L₂*)²+(α₁*−α₂*)²+(b₁*−b₂*)²} (3)

In the formula (3), L₁*, a₁* and b₁* represents the color coordinate values in the CIE 1976 color space in an area 1 (such as one of the frame area 106, the non-touch display area 104 and the touch display area 102), and L₂*, a₂* and b₂* represents the color coordinate values in the CIE 1976 color space in an area 2 (such as another one of the frame area 106, the non-touch display area 104 and the touch display area 102). Referring to Table 3, based on the frame area 106, a chromaticity difference ΔE between the non-touch display area 104 and the frame area 106 is 1.45, and a chromaticity difference ΔE between the touch display area 102 and the frame area 106 is 1.38.

From the above description, according to the design of the display module 100 of the present invention, a difference of average reflectance ΔR to the external light between any two of the touch display area 102, the non-touch display area 104 and the frame area 106 may be less than 1.5% (i.e., ΔR<1.5%), and a chromaticity difference ΔE between any two of the touch display area 102, the non-touch display area 104 and the frame area 106 may be less than 1.5 (i.e., ΔE<1.5). In some embodiments, preferably, the difference of average reflectance ΔR may be less than 1.0% (i.e., ΔR<1.0%), and the chromaticity difference ΔE may be less than 1.0 (i.e., ΔE<1.0). Therefore, the various areas of the display module 100 may be visually consistent, so that the display module can achieve a visual performance wherein the presented color as a whole is uniform when no image is displayed, such as presenting a visual effect of uniform black.

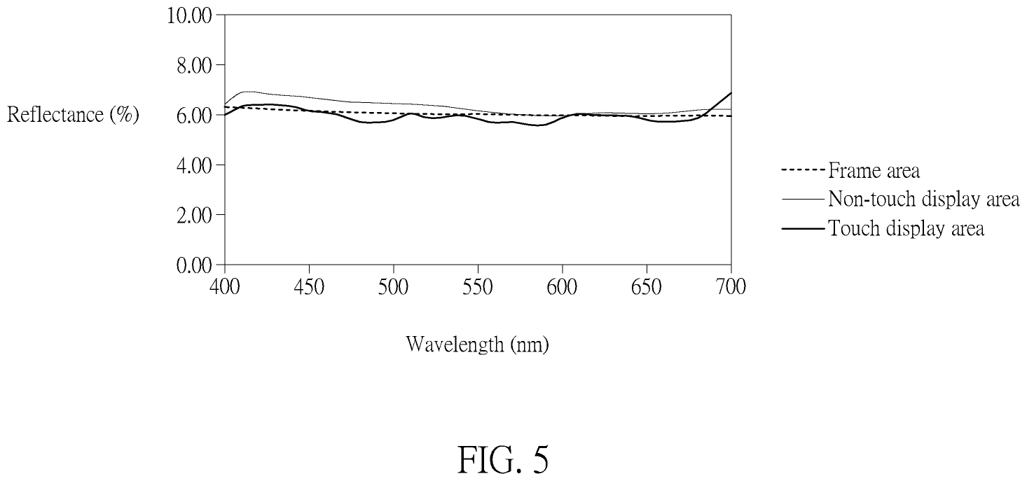

Refer to FIG. 5 and Table 4, along with FIG. 3. FIG. 5 is a schematic diagram of the relationship between the reflectance of different areas of the display module and the measured wavelength according to another embodiment of the present invention. Table 4 exemplified shows the average reflectance Ravg and the difference of average reflectance ΔR to external light and the color coordinate values L*, a* and b* and the chromaticity difference ΔE in the CIE 1976 color space of various areas of the display module 100 according to another embodiment of the present invention. As shown in FIG. 3, FIG. 5 and Table 4, in the display module 100 of this embodiment, the ink layer 120 of the frame area 106 is formed of the highly reflective ink, and the optical matching layer 150 disposed between the touch display panel 130 and the cover plate 110 is an Nb₂O₅ layer (with a layer thickness of 60 Å).

TABLE 4

| | average | | | | | |
|---|---|---|---|---|---|---|
| | reflectance | difference | | | | chroma- |
| | Ravg (%) | of average | | | | ticity |
| | (wavelength: | reflectance | color coordinate value | | | difference |
| area | 400-700 nm) | ΔR (%) | L* | a* | b* | ΔE |
| frame area | 6.05 | | 29.46 | 0.02 | −0.59 | |
| 106 | | | | | | |
| non-touch | 6.30 | 0.26 | 29.89 | −0.26 | −1.94 | 1.45 |
| display | | | | | | |
| area 104 | | | | | | |
| touch | 6.00 | 0.19 | 29.03 | 0.65 | −1.24 | 1.00 |
| display | | | | | | |
| area 102 | | | | | | |

Referring to Table 4, based on the frame area 106, a difference of average reflectance ΔR to external light (visible light with the wavelength ranging from 400 nm to 700 nm) between the non-touch display area 104 and the frame area 106 is 0.26%, and a difference of average reflectance ΔR to external light (with the wavelength ranging from 400 nm to 700 nm) between the touch display area 102 and the frame area 106 is 0.19%. Furthermore, based on the frame area 106, a chromaticity difference ΔE between the non-touch display area 104 and the frame area 106 is 1.45, and a chromaticity difference ΔE between the touch display area 102 and the frame area 106 is 1.00. From the above description, in the display module 100 of this embodiment, the difference of average reflectance ΔR to the external light between any two of the touch display area 102, the non-touch display area 104 and the frame area 106 may be less than 1.5%, and the chromaticity difference ΔE between any two of the touch display area 102, the non-touch display area 104 and the frame area 106 may be less than 1.5.

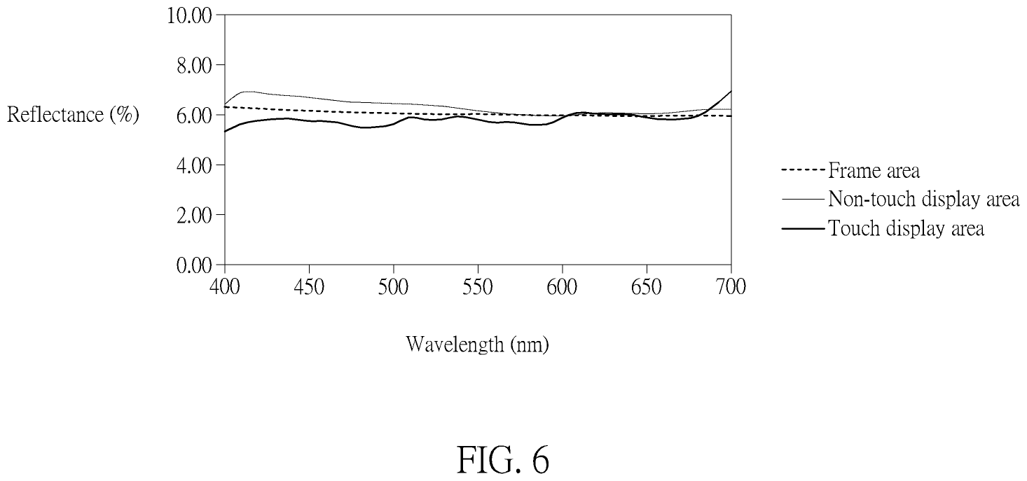

Refer to FIG. 6 and Table 5, along with FIG. 3. FIG. 6 is a schematic diagram of the relationship between the reflectance of different areas of the display module and the measured wavelength according to yet another embodiment of the present invention. Table 5 exemplified shows the average reflectance Ravg and the difference of average reflectance ΔR to external light and the color coordinate values L*, a* and b* and the chromaticity difference ΔE in the CIE 1976 color space of various areas of the display module 100 according to yet another embodiment of the present invention. As shown in FIG. 3, FIG. 6 and Table 5, in the display module 100 of this embodiment, the ink layer 120 of the frame area 106 is formed of the highly reflective ink, and the optical matching layer 150 disposed between the touch display panel 130 and the cover plate 110 is a SiOₓN_{y} layer (with a layer thickness of 120 Å).

TABLE 5

| | average | | | | | |
|---|---|---|---|---|---|---|
| | reflectance | difference | | | | chroma- |
| | Ravg (%) | of average | | | | ticity |
| | (wavelength: | reflectance | color coordinate value | | | difference |
| area | 400-700 nm) | ΔR (%) | L* | a* | b* | ΔE |
| frame area | 6.05 | | 29.46 | 0.02 | −0.59 | |
| 106 | | | | | | |
| non-touch | 6.30 | 0.26 | 29.89 | −0.26 | −1.94 | 1.45 |
| display | | | | | | |
| area 104 | | | | | | |
| touch | 5.85 | 0.33 | 28.90 | 0.44 | 0.32 | 1.15 |
| display | | | | | | |
| area 102 | | | | | | |

Referring to Table 5, based on the frame area 106, a difference of average reflectance ΔR to external light (visible light with the wavelength ranging from 400 nm to 700 nm) between the non-touch display area 104 and the frame area 106 is 0.26%, and a difference of average reflectance ΔR to external light (with the wavelength ranging from 400 nm to 700 nm) between the touch display area 102 and the frame area 106 is 0.33%. Furthermore, based on the frame area 106, a chromaticity difference ΔE between the non-touch display area 104 and the frame area 106 is 1.45, and a chromaticity difference ΔE between the touch display area 102 and the frame area 106 is 1.15. From the above description, in the display module 100 of this embodiment, the difference of average reflectance ΔR to the external light between any two of the touch display area 102, the non-touch display area 104 and the frame area 106 may be less than 1.5%, and the chromaticity difference ΔE between any two of the touch display area 102, the non-touch display area 104 and the frame area 106 may be less than 1.5.

Refer to FIG. 7. FIG. 7 is a partial cross-sectional schematic diagram of a display module according to a second embodiment of the present invention. In some embodiments, as shown in FIG. 7, the optical matching layer 150 may be disposed between the non-touch display panel 140 and the cover plate 110, so that a difference of average reflectance ΔR to external light between any two of the touch display area 102, the non-touch display area 104 and the frame area 106 is less than 1.5%, and a chromaticity difference ΔE between any two of the touch display area 102, the non-touch display area 104 and the frame area 106 is less than 1.5. In addition, the adhesive layer 162 is disposed between the non-touch display panel 140 and the optical matching layer 150 to attach the non-touch display panel 140 to the optical matching layer 150, and the adhesive layer 160 is disposed between the touch display panel 130 and both the cover plate 110 and the ink layer 120 to attach the touch display panel 130 to the cover plate 110 and the ink layer 120. The material, number of layers, and thickness range of the optical matching layer 150 may be known by referring to the embodiments described above, and will not be repeated herein.

As shown in FIG. 7, the touch display panel 130 may include the first substrate 134, the display layer 136, the second substrate 138 and the touch layer 132 stacked in sequence in the direction opposite to the top-view direction V, so as to form an on-cell touch display panel, but not limited herein.

In the manufacturing process of the display module 100 of the second embodiment, the patterned optical matching layer 150 may be formed after the ink layer 120 is formed on the surface of the cover plate 110. For example, the material layer of the optical matching layer 150 may be formed on the surface of the cover plate 110 by a process such as coating, printing or thin-film deposition, and a mask may be used to remove a portion of the material layer for patterning when it was formed blanketly or with a large area, so that the remaining material layer corresponds to the non-touch display area 104 and a portion of the frame area 106 surrounding the non-touch display area 104 to form the optical matching layer 150. In this method, the optical matching layer 150 is formed on the surfaces of the cover plate 110 and the ink layer 120. Then, the non-touch display panel 140 may be attached to the optical matching layer 150 through the adhesive layer 162, and the touch display panel 130 may be attached to the cover plate 110 and the ink layer 120 through the adhesive layer 160, but not limited herein.

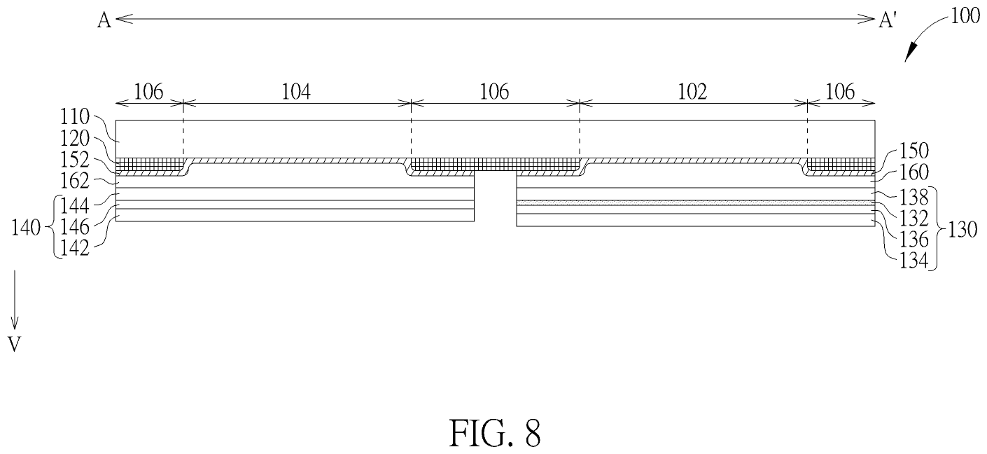

Refer to FIG. 8. FIG. 8 is a partial cross-sectional schematic diagram of a display module according to a third embodiment of the present invention. In some embodiments, the display module 100 may include the optical matching layer 150 and another optical matching layer 152. The optical matching layer 150 is disposed between the touch display panel 130 and the cover plate 110, and the optical matching layer 152 is disposed between the non-touch display panel 140 and the cover plate 110, so that a difference of average reflectance ΔR to external light between any two of the touch display area 102, the non-touch display area 104 and the frame area 106 is less than 1.5%, and a chromaticity difference ΔE between any two of the touch display area 102, the non-touch display area 104 and the frame area 106 is less than 1.5. The optical matching layer 150 and the optical matching layer 152 may respectively include the same or different layers and/or materials, and the optical matching layer 150 and the optical matching layer 152 may be manufactured by the same or different process materials, and the forming methods thereof may be known by referring to the embodiments described above, and will not be repeated herein.

From the above description, according to the display module of the present invention, through the matching of the optical matching layer and the panel, the difference of average reflectance between the touch display area, the non-touch display area and the frame area may be designed as less than 1.5%, and the chromaticity difference therebetween may be designed as less than 1.5, so that these areas are visually consistent. Therefore, the display module can achieve a visual performance with a consistent color appearance when no image is displayed, for example, presenting a visual effect of uniform black. In addition, by disposing high reflective ink in the frame area, the visual consistency of the display module may be further improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display module, having at least one touch display area, at least one non-touch display area and a frame area, wherein the frame area surrounds the touch display area and the non-touch display area, the display module comprising:
a cover plate;
an ink layer disposed on a surface of the cover plate and corresponding to the frame area;
at least one touch display panel disposed on a side of the ink layer opposite to the cover plate and corresponding to the touch display area;
at least one non-touch display panel disposed on a side of the ink layer opposite to the cover plate and corresponding to the non-touch display area; and
an optical matching layer disposed between the cover plate and one of the touch display panel and the non-touch display panel,
wherein a difference of average reflectance to external light between any two of the touch display area, the non-touch display area and the frame area is less than 1.5%, and a chromaticity difference between any two of the touch display area, the non-touch display area and the frame area is less than 1.5.

2. The display module according to claim 1, wherein the difference of average reflectance to external light between any two of the touch display area, the non-touch display area and the frame area is less than 1.0%, and the chromaticity difference between any two of the touch display area, the non-touch display area and the frame area is less than 1.0.

3. The display module according to claim 1, wherein the ink layer comprises a high reflective ink, and an L* value of the high reflective ink in CIE 1976 color space is greater than 28.

4. The display module according to claim 1, wherein the optical matching layer is disposed between the ink layer and the one of the touch display panel and the non-touch display panel.

5. The display module according to claim 4, further comprising an adhesive layer disposed between the optical matching layer and the one of the touch display panel and the non-touch display panel.

6. The display module according to claim 1, further comprising another optical matching layer disposed between the cover plate and another one of the touch display panel and the non-touch display panel.

7. The display module according to claim 1, wherein the optical matching layer covers the cover plate and the ink layer stepwise.

8. The display module according to claim 1, wherein the optical matching layer is a single-layer structure.

9. The display module according to claim 8, wherein a material of the optical matching layer comprises niobium pentoxide (Nb₂O₅), titanium dioxide (TiO₂), tantalum pentoxide (Ta₂O₅), silicon oxynitride (SiOₓN_{y}), silicon nitride (Si₃N₄), silicon dioxide (SiO₂) or magnesium fluoride (MgF₂).

10. The display module according to claim 1, wherein the optical matching layer comprises at least one first sub-layer and at least one second sub-layer which are alternately stacked, and a refractive index of the first sub-layer is greater than a refractive index of the second sub-layer.

11. The display module according to claim 10, wherein a material of the first sub-layer comprises niobium pentoxide (Nb₂O₅), titanium dioxide (TiO₂), tantalum pentoxide (Ta₂O₅), silicon oxynitride (SiOₓN_{y}) or silicon nitride (Si₃N₄), and a material of the second sub-layer comprises silicon dioxide (SiO₂) or magnesium fluoride (MgF₂).

12. The display module according to claim 1, wherein the touch display panel comprises a touch layer.
